(19) United States
(12) Patent Application Publication
(10) Pub. No.: US 2022/0274367 A1
(43) Pub. Date: Sep. 1, 2022

(54) COATING PROCESS OF SEGMENTED PAPER PULP BOTTLE BLANKS AND PRODUCTION PROCESS OF SEGMENTED PAPER PULP BOTTLES

(71) Applicant: SHURCON MANUFACTURING (ZHEJIANG) CO., LTD., Jiaxing (CN)

(72) Inventors: KAI WANG, JIAXING (CN); WEIMIN CHEN, JIAXING (CN); JIANHUA JIAO, JIAXING (CN)

(21) Appl. No.: 17/740,234

(22) Filed: May 9, 2022

Related U.S. Application Data
(63) Continuation of application No. PCT/CN2020/128875, filed on Nov. 14, 2020.

(30) Foreign Application Priority Data
Nov. 15, 2019 (CN) 2019111226080

(51) Int. Cl. B31B 50/64; B31B 50/62; B31B 50/59

(52) U.S. Cl. CPC B31B 50/64; B31B 50/624; B31B 50/592; B31B 2105/00

(57) ABSTRACT

A coating process of a segmented paper pulp bottle blank includes: S1, placing a film raw material into a bottle blank to be coated; S2, folding an upper edge of the film raw material to fix the upper edge onto a mouth of the bottom blank; S3, placing the bottle blank fixed with the film raw material into a coating mold; S4, placing a hot-air blowing pipe into the bottle blank; and S5, sucking air by the coating mold to absorb the bottle blank onto inner cavity walls of the coating mold, blowing in hot air by the hot-air blowing pipe to make the film raw materia1, after being heated and softened, to be expanded and adhered to the inner wall of the bottle blank, and finally opening the coating mold to take out a finished product. Moreover, a production process of a segmented paper pulp bottle is provided.

### CROSS-REFERENCE TO RELATED APPLICATIONS

This application is a continuation of International Application No. PCT/CN2020/128875, filed on Nov. 14, 2020. The International Application claims a priority to a Chinese patent application No. 201911122608.0 filed to the China National Intellectual Property Administration on Nov. 15, 2019. The entire contents of the above-mentioned applications are hereby incorporated by reference in its entirety.

### TECHNICAL FIELD

The present disclosure relates to the field of paper pulp bottle production technologies, in particular to a coating process of a segmented paper pulp bottle blank and a production process of a segmented paper pulp bottle.

### BACKGROUND

Beverage bottles are generally fabricated by employing polyester (PET), polyethylene (PE) and polypropylene (PP) as raw materials, adding corresponding organic solvents and heating at high temperatures, and then being molded through plastic molds by blow molding, extrusion blowing or injection molding. Since plastics are difficult to degrade and have low recycling rates, and thus it is not environmentally friendly. At present, many items begin to use paper environmental protection materials, such as handbags and milk bags. However, there is no precedent of using paper materials to make beverage bottles, but the paper materials are feasible to be used in the production of beverage bottles owing to their hardness and shapability. Therefore, taking paper materials as main production materials of beverage bottles will not only be environmentally friendly and safe, but also achieve more beautiful and grand appearances than plastic bottles, and thus would be loved by more people.

However, a bottle made based on the paper material needs to adhere a layer of film on its inner wall, so that the bottle can still maintain its function after encountering water. An existing film coating equipment for paper pulp bottles has a complex structure and a cumbersome process, resulting in the cost of paper pulp bottles is very high and the manufacturing process is very long, which is not conducive to reducing the cost and thereby it is not conductive to popularization and use.

### SUMMARY

Objectives of the present disclosure are to overcome the shortcomings of the related art and thus provide a coating process of a segmented paper pulp bottle blank and a production process of a segmented paper pulp bottle.

The objectives of the present disclosure are achieved through technical solutions as follows.

Specifically, a coating process of a segmented paper pulp bottle blank, including:

S1, placing a film raw material into a bottle blank to be coated;

S2, folding an upper edge of the film raw material to fix the upper edge on a mouth of the bottle blank to be coated;

S3, placing the bottle blank to be coated which is fixed with the film raw material into a coating mold;

S4, inserting a hot-air blowing pipe into the bottle blank to be coated; and

S5, sucking air by the coating mold to absorb the bottle blank to be coated onto inner cavity walls of the coating mold, blowing in hot air by the hot-air blowing pipe to make the film raw materia1, after being heated and soften by the hot air, be expanded and attached onto an inner wall of the bottle blank to be coated, and then opening the coating mold to take out a finished product.

In an embodiment, in the step S5, a temperature of the hot air blown in by the hot-air blowing pipe is no less than 300 degrees Celsius (° C.).

In an embodiment, the coating mold includes a half-mold A, a half-mold B, a sealing plate A and a sealing plate B; the half-mold A and the half-mold B are mating with each other, a side of the half-mold A facing towards the half-mold B is defined with a bottle-receiving cavity A, a side of the half-mold B facing towards the half-mold A is defined with a bottle-receiving cavity B, the bottle-receiving cavity A and the bottle-receiving cavity B together define a coating cavity, a sidewall of the coating cavity are defined with a plurality of air-suction holes evenly arranged at intervals, another side of the half-mold A facing away from the half-mold B is sealingly connected to the sealing plate A, the sealing plate A and the half-mold A together define an air-suction cavity A, another side of the half-mold B facing away from the half-mold A is sealingly connected to the sealing plate B, the sealing plate B and the half-mold B together define an air-suction cavity B, an air-suction joint A is mounted on the sealing plate A and connected with the air-suction cavity A, and an air-suction joint B is mounted on the sealing plate B and connected with the air-suction cavity B.

In an embodiment, the half-mold A and the half-mold B are defined with connection holes for connecting the air-suction cavity A and with the air-suction cavity B.

In an embodiment, an outer wall of the sealing plate A is formed with a recess A for mounting the air-suction joint A, and the air-suction joint A is embedded and mounted in the recess A.

In an embodiment, an outer wall of the sealing plate B is formed with a recess B for mounting the air-suction joint B, and the air-suction joint B is embedded and mounted in the recess B.

In an embodiment, the plurality of air-suction holes are distributed in a rectangular array on the sidewall of the coating cavity.

A production process of a segmented paper pulp bottle, includes:

(i), preparing a bottle upper part blank and a bottle lower part blank individually, wherein an inner wall of the bottle lower part blank is provided with an inner ring-shaped step;

(ii), placing the bottle upper part blank into a recess-processing mold to form an outer ring-shaped step on an outer wall of the bottle upper part blank, wherein the outer ring-shaped step is capable of connecting with the inner ring-shaped step on the bottle lower part blank;

(iii), connecting the bottle lower part blank with the bottle upper part blank to obtain a bottle blank, and the outer ring-shaped step mating with the inner ring-shaped step; and

(iv) coating the bottle blank through the coating process according to claim 1 to obtain a finished product.

In an embodiment, in the step (iii), during connecting the bottle lower part blank with the bottle upper part blank, coating a layer of adhesive on a surface of the outer ring-shaped step and then fitting the outer ring-shaped step into the inner ring-shaped step.

In an embodiment, the recess-processing mold includes: a concave die, a convex die disposed on the concave die, and a flexible molding member disposed between the concave die and the convex die; the concave die is formed with a cavity bore, an inner sidewall of the cavity bore is formed with a cavity step portion, and a side of the convex die is provided with a convex die cover plate; and during molding, the convex die extends into the bottle upper part blank, and the flexible molding member squeezes an outer sidewall of the bottle upper part blank under an external force to form the outer ring-shaped step.

In an embodiment, the flexible molding member is a flexible bag, and the flexible bag is capable of being filled with a gas or a liquid; during the molding, filling the flexible bag with the gas or the liquid, and the flexible bag deforming and squeezing the outer sidewall of the bottle upper part blank to form the outer ring-shaped step.

In an embodiment, the flexible molding member is a flexible rubber; during the molding, downwardly squeezing the flexible rubber by the convex die cover plate, and the flexible rubber deforming and squeezing the outer sidewall of the bottle upper part blank to form the outer ring-shaped step.

In an embodiment, four corners of the concave die are fixedly mounted with guide columns perpendicular to an upper surface of the concave die respectively, four corners of the convex die cover plate are formed with guide grooves respectively, and the guide columns are slidably engaged with the guide grooves respectively.

wherein the bottle upper part blank is inserted into the cavity bore, and an outer diameter of the bottle upper part blank is equal to an inner diameter of the cavity bore.

In an embodiment, the flexible molding member is a ring-shaped structure, and the flexible molding member is arranged between the cavity step portion and the bottle upper part blank.

In an embodiment, a depth of the cavity bore is equal to a height of the bottle upper part blank, and the bottle upper part blank is in contact with a bottom of the cavity bore.

In an embodiment, the recess-processing mold includes a rotating tray, an edge of the rotating tray is defined with four bottom die mounting grooves, the four bottom die mounting grooves respectively are fixedly connected bottom dies therein, a top die assembly is disposed above the rotating tray, one of the bottom dies rotated to a top-most position by the rotating tray is located just below the top die assembly, the top die assembly is movably connected six sets of squeezing components therein, an inner die is fixedly connected in the top die assembly, a downward pressing sleeve is disposed above the top die assembly, and an inner wall of the downward pressing sleeve abuts against the six sets of squeezing components.

The present disclosure may have advantages as follows.

(1), the film coating process of the present disclosure is simple, the bottle blank to be coated is adsorbed and fixed by negative pressure adsorption, and then hot air is blown into the film raw material placed in the bottle blank to be coated, on the one hand, it can soften the film raw materia1, and on the other hand, it can blow the film raw material to be expanded and adhered to the inner wall of the bottle blank to be coated, and finally the coating of film is realized. The production cost is low and it is convenient for popularization and use.

(2), the segmented paper pulp bottle blank manufactured by the production process of a segmented paper pulp bottle of the present disclosure can use automation in its manufacturing process, the manufacturing cost is low, and the material cost of the segmented paper pulp bottle is also low, so that the cost of the whole product is low, which is conducive to popularization and application, and can reduce the generation of plastic pollution.

### BRIEF DESCRIPTION OF DRAWINGS

FIG. 1 illustrates a schematic view of a coating process of a segmented paper pulp bottle blank according to the present disclosure.

FIG. 2 illustrates a schematic structural view of a coating mold according to the present disclosure.

FIG. 3 illustrates a schematic cross-sectional structural view of the coating mold according to the present disclosure.

FIG. 4 illustrates a schematic structural view of a bottle upper part blank (before being molded with an outer ring-shaped step) according to the present disclosure.

FIG. 5 illustrates a schematic structural view of the bottle upper part blank (being molded with the outer ring-shaped step) according to the present disclosure.

FIG. 6 illustrates a schematic structural view of a recess-processing mold according to embodiment 1 of the present disclosure.

FIG. 7 illustrates a schematic cross-sectional structural view of the recess-processing mold according to the embodiment 1 of the present disclosure.

FIG. 8 illustrates a schematic enlarged structural view of portion A in FIG. 7.

FIG. 9 illustrates a schematic structural view of the recess-processing mold using a flexible soft bag as a flexible molding member according to the embodiment 1 of the present disclosure.

FIG. 10 illustrates a schematic structural view of the recess-processing mold using a flexible soft rubber as the flexible molding member according to the embodiment 1 of the present disclosure.

FIG. 11 illustrates a schematic first perspective structural view of embodiment 2 according to the present disclosure.

FIG. 12 illustrates a schematic second perspective structural view of the embodiment 2 according to the present disclosure.

FIG. 13 illustrates a schematic structural view of squeezing components and an inner die in the embodiment 2 according to the present disclosure.

FIG. 14 illustrates a schematic assembled structural view of an arc-shaped squeeze block, a bottom die and an inner die in the embodiment 2 according to the present disclosure.

FIG. 15 illustrates a schematic structural view of a rotating tray with bottom die mounting grooves and a rotating mechanism mounting groove in the embodiment 2 according to the present disclosure.

FIG. 16 illustrates a schematic structural view of the bottom die in the embodiment 2 according to the present disclosure.

FIG. 17 illustrates a schematic cross-sectional structural view of the bottom die in the embodiment 2 according to the present disclosure.

FIG. 18 illustrates a schematic first perspective structural view of a top die assembly in the embodiment 2 according to the present disclosure.

FIG. 19 illustrates a schematic second perspective structural view of the top die assembly in the embodiment 2 according to the present disclosure.

FIG. 20 illustrates a schematic partial structural view of the squeezing component in the embodiment 2 of the present disclosure.

FIG. 21 illustrates a schematic structural view of the inner die in the embodiment 2 according to the present disclosure.

FIG. 22 illustrates a schematic first perspective structural view of a downward pressing sleeve in the embodiment 2 according to the present disclosure.

FIG. 23 illustrates a schematic second perspective structural view of the downward pressing sleeve in the embodiment 2 according to the present disclosure.

### DESCRIPTION OF REFERENCE NUMERALS

a1—half-mold A, a2—half-mold B, a3—sealing plate A, a4—sealing plate B, a5—air-suction joint A, a6—air-suction joint B, a7—air-suction cavity A, a8—air-suction cavity B, a9—coating cavity, a10—air-sunction hole, a11—connection hole;

b1—concave die, b101—cavity bore, b102—cavity step portion, b103—guide column, b2—convex die, b201—convex die cover plate, b202—guide groove, b3—flexible molding member;

c1—rotating tray, c2—bottom die mounting groove, c3—bottom die, c31—bottom die fixing plate, c32—bottom die sleeve, c33—bottle mouth limit groove, c34—bottle mouth limit block, c4—top die assembly, c41—top die sleeve, c42—limit hole, c43—connection post, c44—top die mounting plate, c45—inner die mounting hole, c46—inner die limit groove, c5—squeezing component, c51—arc-shaped squeeze block, c52—threaded hole, c53—stud, c54—limit plate, c55—mounting groove, c56—limit column, c57—return spring, c58—mounting hole, c59—pulley, c6—inner die, c61—guide sleeve, c62—limit sleeve, c63—fixing column, c64—inner die fixing plate, c7—downward pressing sleeve, c8—downward pressing assembly mounting groove, c9—rotating mechanism mounting groove, c10—rotating mechanism fixing plate, c11—rotation electric motor, c12—support;

d1—bottle upper part blank, d11—outer ring-shaped step.

### DETAILED DESCRIPTION OF EMBODIMENTS

The present disclosure will be further described below with reference to the accompanying drawings, but the protection scope of the present disclosure is not limited to the following description.

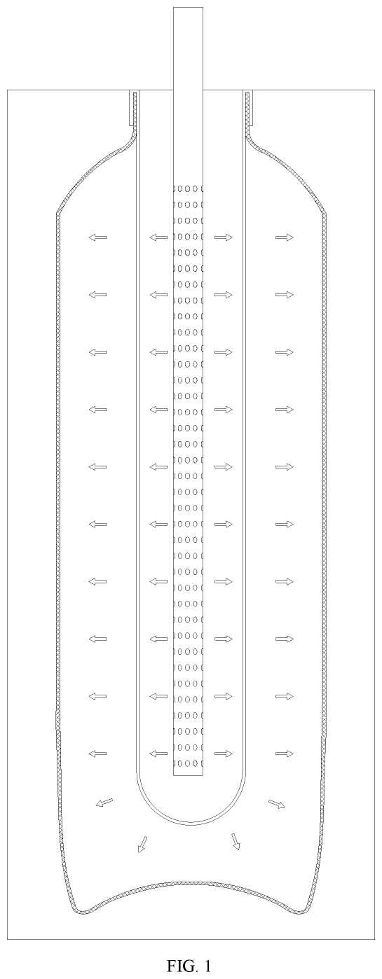

As illustrated in FIG. 1, a coating process (e.g., laminating process) of a segmented paper pulp bottle blank may include steps S1˜S5 as follows.

S1, placing a film raw material into a bottle blank to be coated;

S2, folding an upper edge of the film raw material to fix the upper edge of the film raw material onto a mouth of the bottle blank to be coated;

S3, placing the bottle blank to be coated which is fixed with the film raw material into a coating mold;

S4, inserting a hot-air blowing pipe into the bottle blank to be coated;

S5, sucking air by the coating mold to absorb the bottle blank to be coated onto inner cavity walls of the coating mold, blowing in hot air by the hot-air blowing pipe to make the film raw materia1, after being heated and soften by the hot air, be expanded and attached onto an inner wall of the bottle blank to be coated, and then opening the coating mold to take out a finished product.

In some embodiments, in the step S5, a temperature of the hot air blown in by the hot-air blowing pipe is no less than 300 degrees Celsius (° C.).

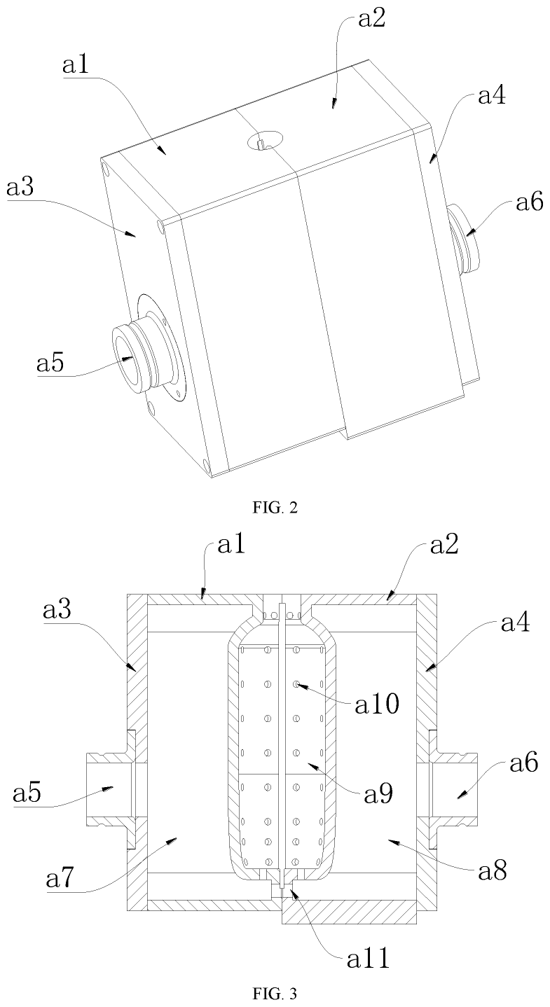

In some embodiments, as illustrated in FIG. 2 and FIG. 3, the coating mold for the paper pulp bottle blank may include: a half-mold A (also referred to as first half-mold) a1, a half-mold B (also referred to as second half-mold) a2, a sealing plate A (also referred to as first sealing plate) a3, and a sealing plate B (also referred to as second sealing plate) a4. The half-mold A a1 is mating with the half-mold B a2. It is noted that, in the illustrated embodiment, connections of the half-mold A a1 and the half-mold B a2 with an external mold holder use conventional connections, which are not the focus of the present disclosure, and thus the connection relationships of the half-mold A a1 and the half-mold B a2 with the external mold holder will not be described in detail herein. A side of the half-mold A a1 facing towards the half-mold B a2 is defined with a bottle-receiving cavity A (also referred to as first bottle-receiving cavity), a side of the half-mold B a2 facing towards the half-mold A a1 is defined with a bottle-receiving cavity B (also referred to as second bottle-receiving cavity), and the bottle-receiving cavity A and the bottle-receiving cavity B cooperatively define a coating cavity a9. A shape of the coating cavity a9 is consistent with a shape of the bottle blank to be coated. A sidewall of the coating cavity a9 is defined with a number of air-suction holes a11) evenly arranged at intervals. Another side of the half-mold A a1 facing away from the half-mold B a2 is sealingly connected to the sealing plate A a3, and the sealing plate A a3 and the half-mold A a1 cooperatively define an air-suction cavity A (also referred to as first air-suction cavity) a7. Another side of the half-mold B a2 facing away from the half-mold A a1 is sealingly connected to the sealing plate B a4, and the sealing plate B a4 and the half-mold B a2 cooperatively define an air-suction cavity B (also referred to as second air-suction cavity) a8. An air-suction joint A (also referred to as first air-suction joint) a5 is mounted on the sealing plate A a3 and connected with the air-suction cavity A a7. An air-suction joint B (also referred to as second air-suction joint) a6 is mounted on the sealing plate B a4 and connected with the air-suction cavity B a8.

In some embodiment, as illustrated in FIG. 3, the half-mold A a1 and the half-mold B a2 are provided with connection holes all for connecting the air-suction cavity A a7 with the air-suction cavity B a8, so that air pressures in the air-suction cavity A a7 and the air-suction cavity B a8 are the same, and suction forces applied onto the outer wall surface of the bottle blank to be coated are consistent, thereby preventing the bottle blank to be coated from deformation due to inconsistent suction forces.

In some embodiments, an outer wall of the sealing plate A a3 is formed with a recess A (also referred to as first recess) for mounting the air-suction joint A a5, and the air-suction joint A a5 is embedded and mounted into the recess A. The air-suction joint A a5 employs the embedded mounting manner, which makes it easier to ensure the tightness and prevent air leakage in the air-suction cavity A a7.

In some embodiments, an outer wall of the sealing plate B a4 is formed with a recess B (also referred to as second recess) for mounting the air-suction joint B a6, and the air-suction joint B a6 is embedded and mounted into the recess B. The air-suction joint B a6 employs the embedded mounting manner, which makes it easier to ensure the tightness and prevent air leakage in the air-suction cavity B a8.

In some embodiments, as illustrated in FIG. 3, the air-suction holes a10 are distributed in a rectangular array on the sidewall of the coating cavity a9, to ensure the suction forces on the surface of the bottle blank to be coated are more uniform.

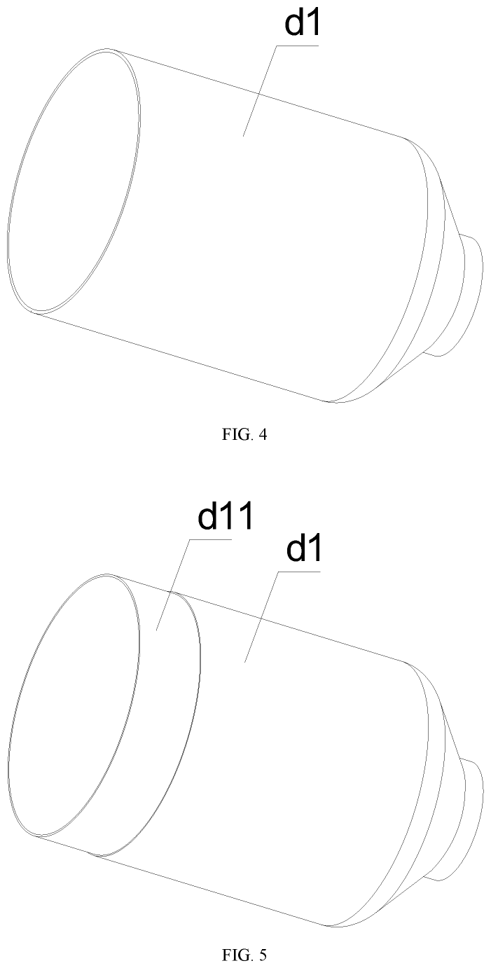

Before introducing a production process of a segmented paper pulp bottle, it is necessary to explain the segmented paper pulp bottle. In particular, the segmented paper pulp bottle includes a bottle upper part blank d1, a bottle lower part blank mating with the bottle upper part blank d1, and an inner coating attached onto inner sides of the bottle upper part blank d1 and the bottle lower part blank. The bottle upper part blank d1 and the bottle lower part blank both can be fabricated by molding. A structure of the bottle upper part blank d1 before being formed with an outer ring-shaped step d11 is shown in FIG. 4 and is a conventional structure, and thus will be repeated herein. However, it should be noted that, a paper pulp bottle cannot be made by blow molding technology, because paper pulp has poor ductility than plastic. The structure and shape of the bottle itself should be that of an object seen every day. In some embodiments of the present disclosure, the bottle is divided into two segments from a middle to form the bottle upper part blank d1 and the bottle lower part blank. In order to connect the bottle upper part blank d1 with the bottle lower part blank smoothly, especially the outer sidewall, to achieve an aesthetic effect, connection portions of the bottle upper part blank d1 and the bottle lower part blank need to be treated in a certain way. In some embodiments of the present disclosure, the inner sidewall of the bottle lower part blank is provided with an inner ring-shaped step. A wall thickness of the inner ring-shaped step is one half of a thickness of the other portion. Correspondingly, it is needed to dispose an outer ring-shaped step d11 on the outer sidewall of the bottle upper part blank d1, as shown in FIG. 5. A wall thickness of the outer ring-shaped step d11 is one half of a thickness of the other portion, so that when the outer ring-shaped step d11 is fitted into the inner ring-shaped step, a sum of the wall thickness of the outer ring-shaped step d11 and the wall thickness of the inner ring-shaped step may be the same as the thickness of the other portions, thus achieving the purpose of aesthetics. In addition, it should be understood that a cross-section of the segmented paper pulp bottle can be circular or other shapes. In the illustrated embodiment, the cross-section of the segmented paper pulp bottle is circular.

A production process of a segmented paper pulp bottle may include steps (i)˜(iv) as follows.

(i), preparing a bottle upper part blank and a bottle lower part blank individually, an inner wall of the bottle lower part blank being provided with an inner ring-shaped step;

(ii), placing the bottle upper part blank into a recess-processing mold to form an outer ring-shaped step, capable of connecting with the inner ring-shaped step on the bottle lower part blank, on an outer wall of the bottle upper part blank;

(iii), connecting the bottle lower part blank with the bottle upper part blank to obtain a bottle blank, and the outer ring-shaped step mating with the inner ring-shaped step;

(iv), coating the bottle blank through the coating process of a segmented paper pulp bottle blank as described above, to obtain a finished product.

In some embodiments, in the step (iii), during connecting the bottle lower part blank with the bottle upper part blank, a layer of adhesive is coated on a surface of the outer ring-shaped step, and then the outer ring-shaped step is fitted into the inner ring-shaped step. The adhesive should be food grade. Of course, this step can be omitted and it can be fixed by adhesion of an inner film or by other methods. Of course, an automated equipment for applying the layer of adhesive onto the surface of the outer ring step is the prior art and can be used directly, and thus it is not described in detail herein.

In the step (ii), the recess-processing mold may have two embodiments as follows.

### Embodiment 1

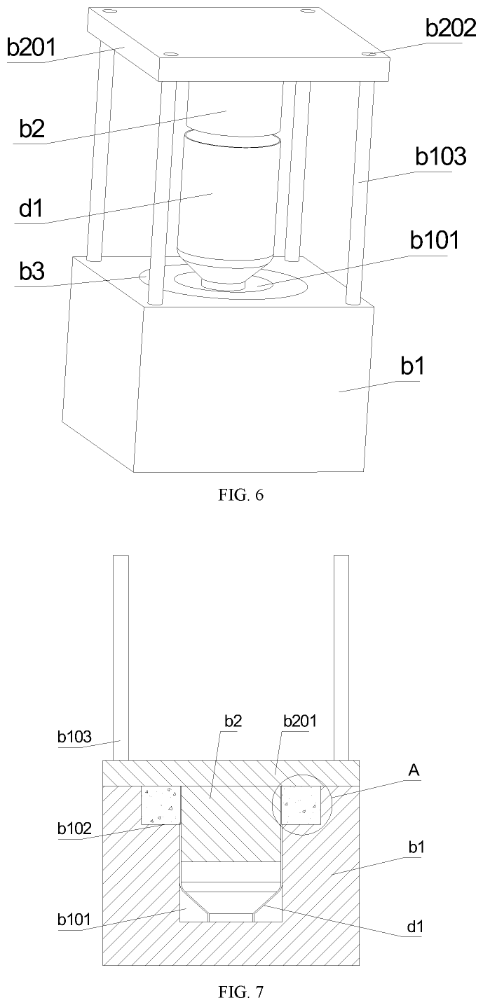

As illustrated in FIG. 6 through FIG. 10, the recess-processing mold may include a concave die b1, a convex die b2 disposed on the concave die b1, and a flexible molding member b3 disposed between the concave die b1 and the convex die b2. The concave die b1 is defined with a cavity bore b101, an inner sidewall of the cavity bore b101 is defined with a cavity step portion b102, and a side of the convex die b2 is provided with a convex die cover plate b201. During molding, the convex die b2 is inserted into the bottle upper part blank d1, the flexible molding member b3 squeezes the outer sidewall of the bottle upper part blank d1 under an external force, and then an outer ring-shaped step d11 is formed. The concave die b1 and the convex die b2 both are made of a hard materia1, such as steel, so as to avoid deformation during the squeezing process. An axial depth of the cavity step portion b102 should be equal to an axial length of the outer ring-shaped step d11. Moreover, in order to facilitate the flexible molding member b3 to fully apply the squeezing force, the convex die cover plate b201, the cavity step portion b102, and the outer sidewall of the bottle upper part blank d1 cooperatively define a closed cavity.

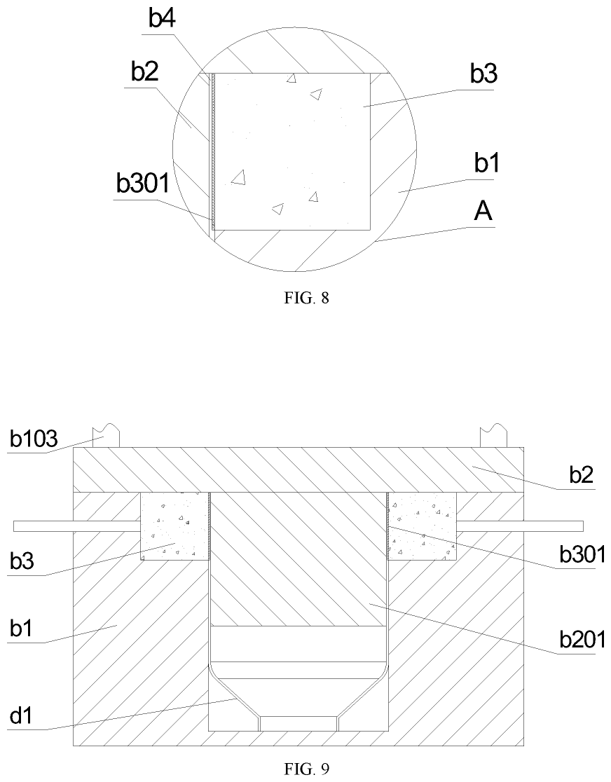

An implementation of the flexible molding member b3 is that, as illustrated in FIG. 9, the flexible molding member b3 is a flexible soft bag, and the flexible soft bag is capable of being filled with a gas or a liquid. During the molding, a gas or a liquid is filled in the flexible soft bag, the flexible soft bag deforms and squeezes the outer sidewall of the bottle upper part blank, and finally an outer ring-shaped step is formed. The flexible soft bag should be made of an expandable or ductile materia1, such as a rubber.

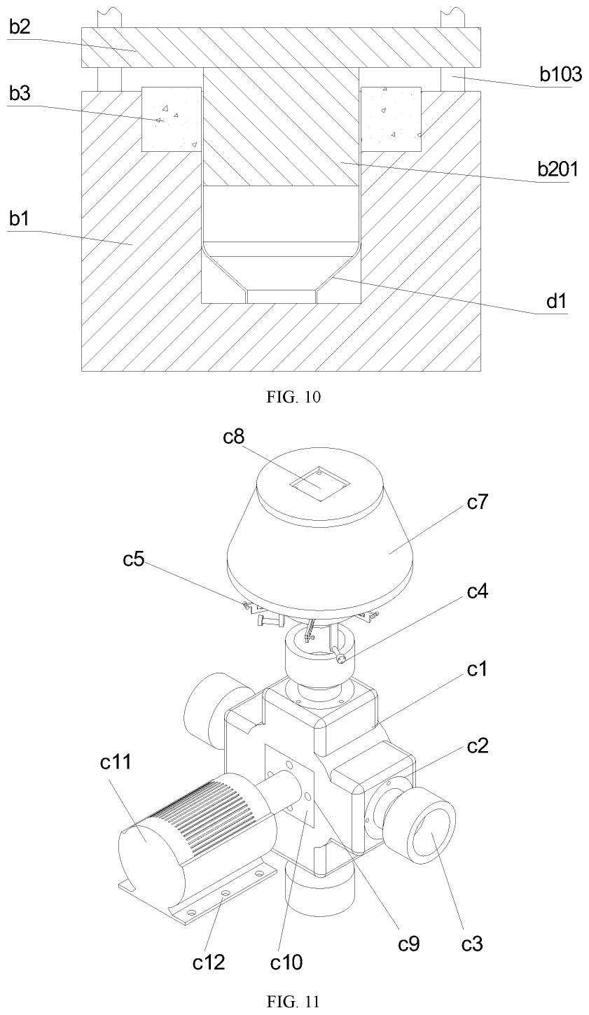

Another implementation of the flexible molding member b3 is that, as illustrated in FIG. 10, the flexible molding member b3 is a flexible soft rubber, and during the molding, the convex die cover plate downwardly squeezes the flexible soft rubber, the flexible soft rubber deforms under the squeezing and squeezes the outer sidewall of the bottle upper part blank, and finally an outer ring-shaped step is formed.

In some embodiments, as illustrated in FIGS. 6-7, four corners of the concave die b1 are fixedly mounted with guide columns b103 perpendicular to an upper surface of the concave die b1 respectively, four corners of the convex die cover plate b201 are disposed with guide grooves b202 respectively, and each of the guide columns b103 is slidably engaged with a corresponding one of the guide grooves b202.

In some embodiments, as illustrated in FIG. 7, the bottle upper part blank d1 is inserted into the cavity bore b101, and an outer diameter of the bottle upper part blank d1 is equal to an inner diameter of the cavity bore b101.

In the illustrated embodiment, the cross-section of the bottle upper part blank d1 is circular, and therefore the flexible molding member b3 is a ring-shaped structure, and the flexible molding member b3 is arranged between the cavity step portion b102 and the bottle upper part blank d1.

In some embodiments, the convex die b2 and the convex die cover plate b201 are integrally formed, i.e., are a one-piece structure, a cross-section profile of the convex die cover plate b201 and a cross-section profile of the concave die b1 are rectangles, and sizes of the two rectangles are the same.

In some embodiments, a depth of the cavity bore b101 is equal to a height of the bottle upper part blank d1, and the bottle upper part blank d1 is in contact with a bottom of the cavity bore b101, so as to achieve an axial positioning of the bottle upper part blank d1 in the cavity bore b101.

### Embodiment 2

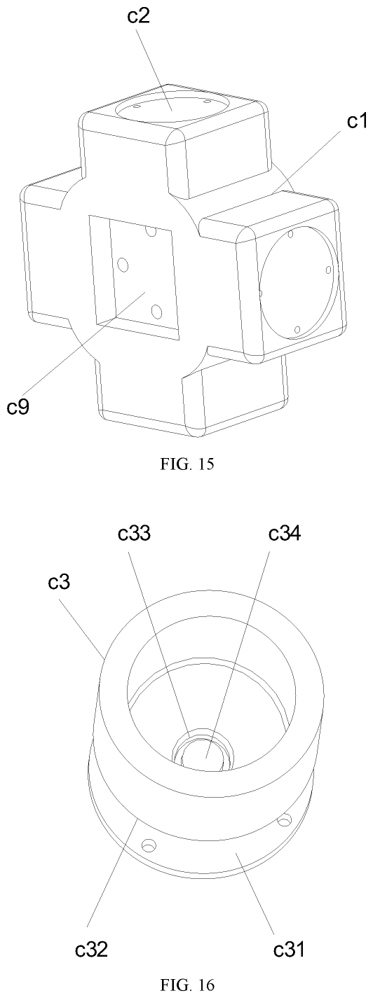

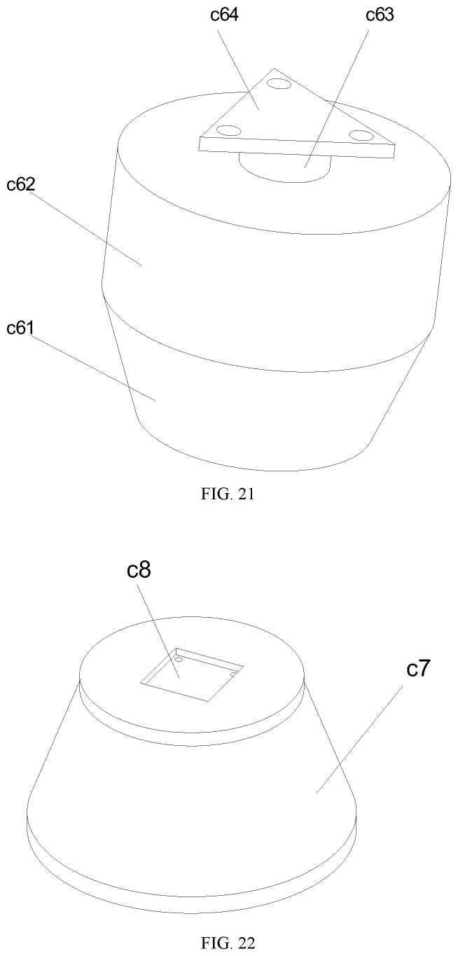

As illustrated in FIG. 11 through FIG. 23, the recess-processing mold may include a rotating tray c1. An edge of the rotating tray c1 is provided with four bottom die mounting grooves c2, and the interior of each of the four bottom die mounting grooves c2 is fixedly connected with a bottom die c3. A top die assembly c4 is disposed above the rotating tray c1. The bottom die c3 rotated to the top-most position by the rotating tray c1 is located just below the top die assembly c4. The top die assembly c4 has six sets of squeezing components c5 movably connected therein, the top die assembly c4 has an inner die c6 fixedly connected therein. A downward pressing sleeve c7 is disposed above the top die assembly c4, and an inner wall of the downward pressing sleeve c7 abuts against the squeezing components c5.

The squeezing component c5 inc1udes an arc-shaped squeeze block c51, a central angle corresponding to the arc-shaped squeeze block c51 is 60 degrees, a middle portion of an outer side of the arc-shaped squeeze block c51 is provided with a threaded hole c52, an internal thread of the threaded hole c52 is connected with a stud c53, a side of the stud c53 is fixedly connected with a limit plate c54, a middle portion of limit plate c54 is defined with a mounting slot c55, a limit column c56 is fixed in the mounting slot c55, a return spring c57 is sleeved on the limit column c56, a side of the limit plate c54 facing away from the stud c53 is provided with a mounting hole c58, a pulley c59 is rotatably connected in the mounting hole c58, and the pulley c59 abuts against the inner wall of the downward pressing sleeve c7.

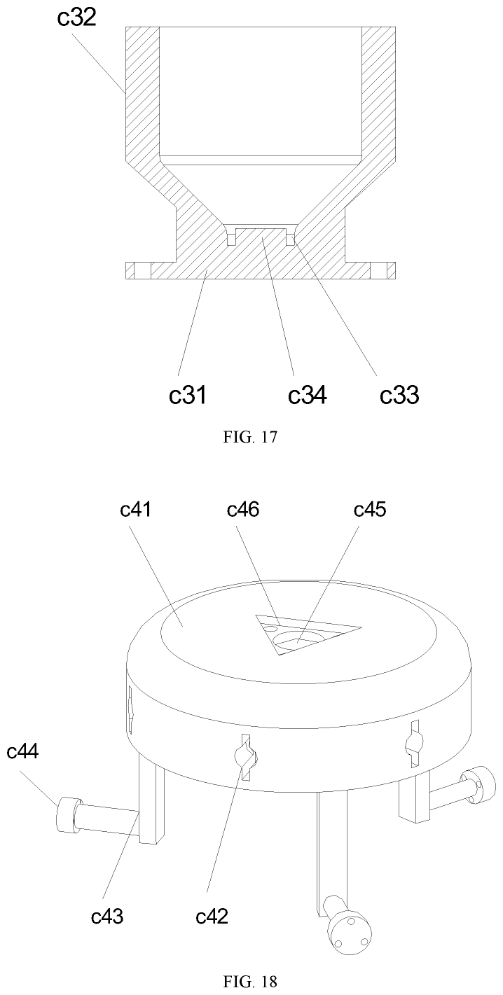

In some embodiments, as illustrated in FIG. 16 and FIG. 17, the bottom die c3 includes a bottom die fixing plate c31, the bottom die fixing plate c31 is fixedly connected in the bottom die mounting groove c2 by screw bolts, a side of the bottom die fixing plate c31 facing away from the bottom die mounting groove c2 is fixedly connected with a bottom die sleeve c32, a bottom portion of an inner cavity of the bottom die sleeve c32 is defined with a bottle mouth limit groove c33, and a bottle mouth limit block c34 is fixedly connected in the bottle mouth limit groove c33.

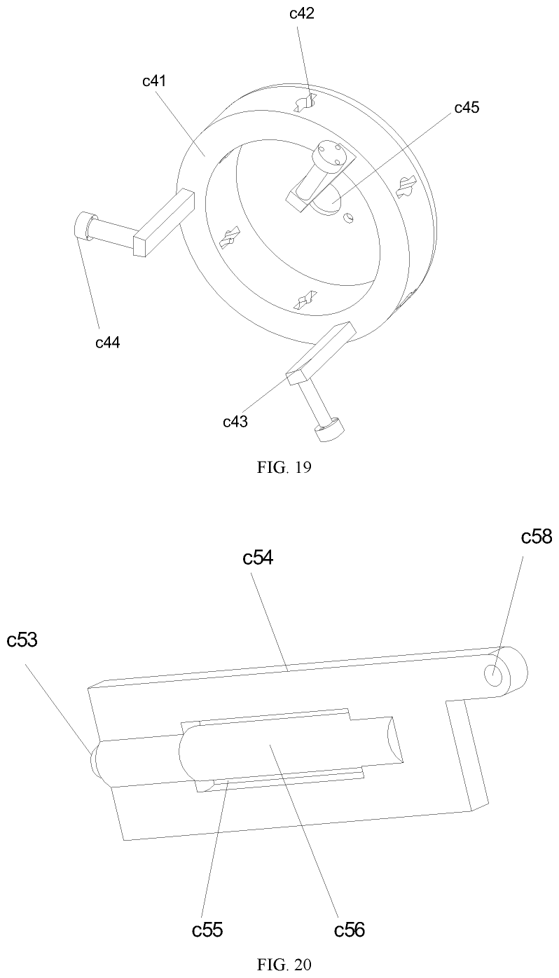

In some embodiments, as illustrated in FIG. 18 and FIG. 19, the top die assembly c4 includes a top die sleeve c41, a side surface of the top die sleeve c41 is provided with limit holes c42 each matchable with the limit plate c54 and the limit column c56, a block plate is disposed in the limit hole c42 to block the return spring c57, an edge of a bottom of the top die sleeve c41 is fixedly connected with three connection posts c43, the three connection posts c43 are arranged in an annular array, and a diameter defined by the three connection posts c43 arranged in the annular array is greater than an outer diameter of the bottom die sleeve c32, a side of each of the three connection posts facing away from the top die sleeve c41 is fixedly connected with a top die mounting plate c44, a top portion of the top die sleeve c41 is defined with an inner die mounting hole c45, and an upper surface of the top die sleeve c41 is defined with an inner die limit groove c46.

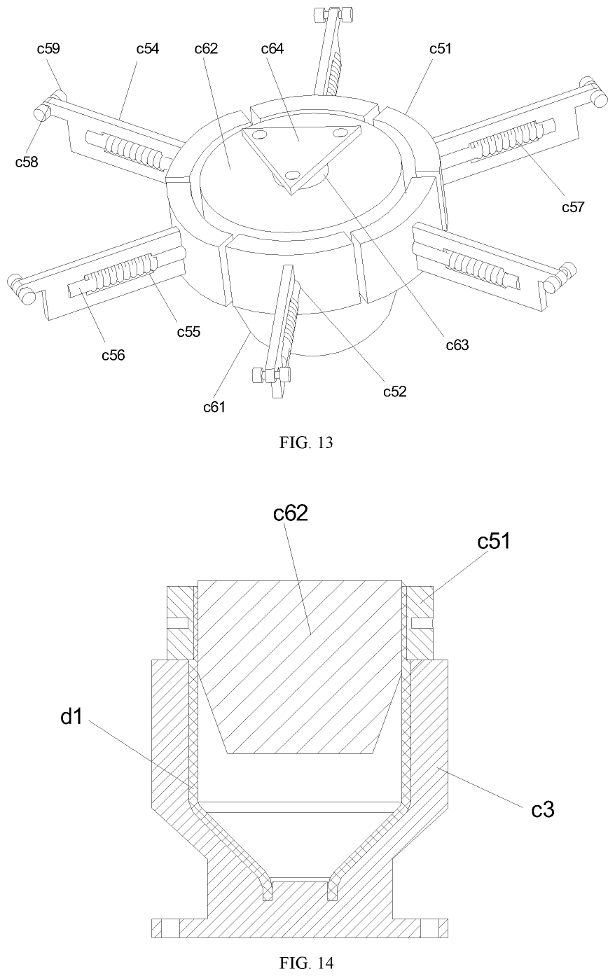

In some embodiments, as illustrated in FIG. 13, the inner die c6 includes a guide sleeve c61, a diameter of the guide sleeve c61 is gradually increased from bottom to top, a top portion of the guide sleeve c61 is fixedly connected with a limit sleeve c62, a top portion of the limit sleeve c62 is threadedly connected with a fixing column c63, the fixing column c63 is inserted into the inner die mounting hole c45, an end of the fixing column c63 facing away from the limit sleeve c62 is fixedly connected with an inner die fixing plate c64.

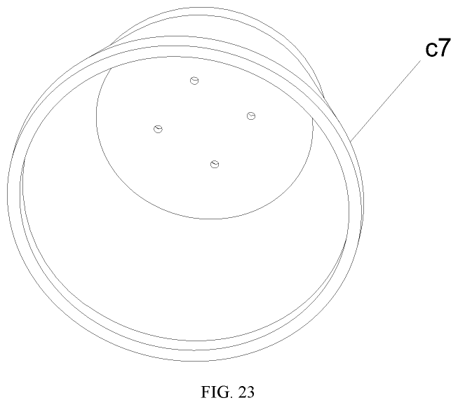

In some embodiments, as illustrated in FIG. 22 and FIG. 23, the downward pressing sleeve c7 is a bottom-opened sleeve, i.e., a sleeve with an opening at the bottom. A diameter of the downward pressing sleeve c7 is gradually increased from top to down, a top portion of the downward pressing sleeve c7 is defined with a downward pressing assembly mounting groove c8, and a downward pressing assembly is mounted in the downward pressing assembly mounting groove c8.

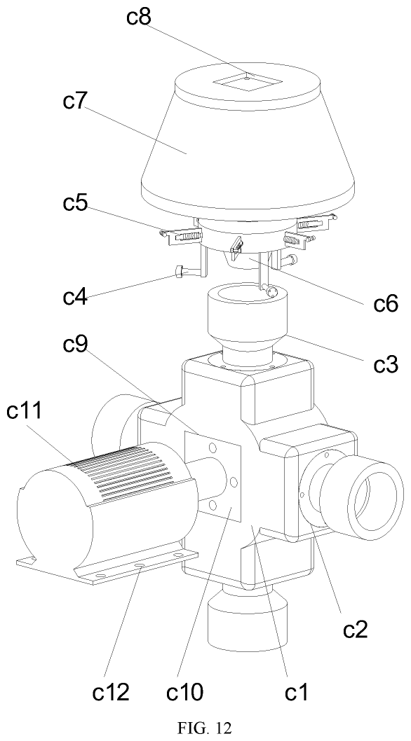

In some embodiments, as illustrated in FIG. 12 and FIG. 14, a side surface of the rotating tray c1 is defined with a rotating mechanism mounting groove c9, and a rotating mechanism fixing plate c10 is fixedly connected in the rotating mechanism mounting groove c9.

Specifically, a side of the rotating mechanism fixing plate c10 facing away from the rotating mechanism mounting groove c9 is connected to an output end of a reducer, and an input end of the reducer is connected to an output end of a rotation electric motor c11.

In some embodiments, as illustrated in FIG. 11, a support c12 is disposed on the bottom of the rotation electric motor c11, and a lifting assembly is mounted on the bottom of the support c12.

In assembling, the arc-shaped squeeze blocks c51 first are placed in the top die sleeve c41, the central angle corresponding to each of the arc-shaped squeeze blocks c51 is 60 degrees, the middle portion of each of the arc-shaped squeeze blocks c51 is provided with the threaded hole c52, the internal thread of the threaded hole c52 is used to connect the stud c53, the arc-shaped squeeze block c51 is screwed on the stud c53, one side of the stud c53 is fixedly connected with the limit plate c54, the middle portion of the limit plate c54 is defined with the mounting slot c55, the middle portion of the mounting slot c55 is fixedly connected with the limit column c56, the outer surface of the limit column c56 is sleeved with the return spring c57, the limit plate c54 and the limit column c56 pass through the limit hoe c42, the return spring c57 abuts against the block plate in the limit hole c42 to supply a return force for the arc-shaped squeeze block c51 to move outwards, the side of the limit plate c54 facing away from the stud c53 is defined with the mounting hole c58, the pulley c59 is rotatably connected in the mounting hole c58, and the pulley c59 abuts against the inner wall of the downward pressing sleeve c7.

The lifting assembly and the downward pressing assembly are mature technologies, each of which can be a cylinder assembly, a hydraulic telescopic rod assembly, an electric push rod assembly, etc., and thus will be not described herein.

Specifically, the bottle upper part blank d1 is placed into the bottom die sleeve c32, then the rotation electric motor c11 drives the rotating tray c1 to rotate, so that the bottom die sleeve c32 placed with the bottle upper part blank d1 is rotated to the top-most position, and then the lifting assembly on the bottom of the rotation electric motor c11 drives the bottle upper part blank d1 to move upwards so that the bottle upper part blank d1 is fixed through the bottom die sleeve c32, the top die sleeve c41 and the limit sleeve c62 and thereby ensuring a normal production of the outer ring-shaped step d11. Afterwards, the downward pressing assembly disposed above the downward pressing sleeve c7 is used to press the downward pressing sleeve c7, and during the process of the downward pressing sleeve c7 being pressed downwardly, the pulleys c59 roll on the inner wall of the downward pressing sleeve c7 to force the six sets of squeezing components c5 to move inwards. Since the central angles of the six arc-shaped squeeze blocks c51 all are 60 degrees, the six arc-shaped squeeze blocks c51 cooperatively form a complete circle after being squeezed, so that the outer surface of the bottle upper part blank d1 can be squeezed to form an outer ring-shaped step d11, achieving the purpose of simple production and good production effect. After forming the outer ring-shaped step d11, the downward pressing sleeve c7 is lifted upwards by the downward pressing assembly, because the return springs c57 are blocked by the block plates in the limit holes c42, the return springs c57 will push the squeezing components c5 to move outwards, so as to separate the arc-shaped squeeze blocks c51 from the bottle upper part blank d1. Subsequently, the lifting assembly drives the bottom die c5 to move downwards, and then the rotation electric motor c11 drives the rotating tray c1 to rotate, so as to rotate the processed bottle upper part blank d1 to the bottom-most position and unload the processed bottle upper part blank d1, which can realize the purpose of high mechanization and improve the production efficiency.

Although the embodiments of the present disclosure have been shown and described, for those skilled in the art, it can be understood that various changes, modifications, substitutions, and variations can be made to these illustrated embodiments without departing from the principle and spirit of the present disclosure, and the scope of the present disclosure is defined by the appended claims and their equivalents.

What is claimed is:

1. A coating process of a segmented paper pulp bottle blank, comprising:
S1, placing a film raw material into a bottle blank to be coated;
S2, folding an upper edge of the film raw material to fix the upper edge on a mouth of the bottle blank to be coated;
S3, placing the bottle blank to be coated which is fixed with the film raw material into a coating mold;
S4, inserting a hot-air blowing pipe into the bottle blank to be coated; and
S5, sucking air by the coating mold to absorb the bottle blank to be coated onto inner cavity walls of the coating mold, blowing in hot air by the hot-air blowing pipe to make the film raw materia1, after being heated and soften by the hot air, be expanded and attached onto an inner wall of the bottle blank to be coated, and then opening the coating mold to take out a finished product.

2. The coating process according to claim 1, wherein in the step S5, a temperature of the hot air blown in by the hot-air blowing pipe is no less than 300 degrees Celsius (° C.).

3. The coating process according to claim 1, wherein the coating mold comprises a half-mold A, a half-mold B, a sealing plate A and a sealing plate B; the half-mold A and the half-mold B are mating with each other, a side of the half-mold A facing towards the half-mold B is defined with a bottle-receiving cavity A, a side of the half-mold B facing towards the half-mold A is defined with a bottle-receiving cavity B, the bottle-receiving cavity A and the bottle-receiving cavity B together define a coating cavity, a sidewall of the coating cavity are defined with a plurality of air-suction holes evenly arranged at intervals, another side of the half-mold A facing away from the half-mold B is sealingly connected to the sealing plate A, the sealing plate A and the half-mold A together define an air-suction cavity A, another side of the half-mold B facing away from the half-mold A is sealingly connected to the sealing plate B, the sealing plate B and the half-mold B together define an air-suction cavity B, an air-suction joint A is mounted on the sealing plate A and connected with the air-suction cavity A, and an air-suction joint B is mounted on the sealing plate B and connected with the air-suction cavity B.

4. The coating process according to claim 3, wherein the half-mold A and the half-mold B are defined with connection holes for connecting the air-suction cavity A and with the air-suction cavity B.

5. The coating process according to claim 3, wherein an outer wall of the sealing plate A is formed with a recess A for mounting the air-suction joint A, and the air-suction joint A is embedded and mounted in the recess A.

6. The coating process according to claim 3, wherein an outer wall of the sealing plate B is formed with a recess B for mounting the air-suction joint B, and the air-suction joint B is embedded and mounted in the recess B.

7. The coating process according to claim 3, wherein the plurality of air-suction holes are distributed in a rectangular array on the sidewall of the coating cavity.

8. A production process of a segmented paper pulp bottle, comprising:
(i), preparing a bottle upper part blank and a bottle lower part blank individually, wherein an inner wall of the bottle lower part blank is provided with an inner ring-shaped step;
(ii), placing the bottle upper part blank into a recess-processing mold to form an outer ring-shaped step on an outer wall of the bottle upper part blank, wherein the outer ring-shaped step is capable of connecting with the inner ring-shaped step on the bottle lower part blank;
(iii), connecting the bottle lower part blank with the bottle upper part blank to obtain a bottle blank, and the outer ring-shaped step mating with the inner ring-shaped step; and
(iv) coating the bottle blank through the coating process according to claim 1 to obtain a finished product.

9. The production process according to claim 8, wherein in the step (iii), during connecting the bottle lower part blank with the bottle upper part blank, coating a layer of adhesive on a surface of the outer ring-shaped step and then fitting the outer ring-shaped step into the inner ring-shaped step.

10. The production process according to claim 9, wherein the recess-processing mold comprises: a concave die, a convex die disposed on the concave die, and a flexible molding member disposed between the concave die and the convex die; the concave die is formed with a cavity bore, an inner sidewall of the cavity bore is formed with a cavity step portion, and a side of the convex die is provided with a convex die cover plate; and during molding, the convex die extends into the bottle upper part blank, and the flexible molding member squeezes an outer sidewall of the bottle upper part blank under an external force to form the outer ring-shaped step.

11. The production process according to claim 10, wherein the flexible molding member is a flexible bag, and the flexible bag is capable of being filled with a gas or a liquid; during the molding, filling the flexible bag with the gas or the liquid, and the flexible bag deforming and squeezing the outer sidewall of the bottle upper part blank to form the outer ring-shaped step.

12. The production process according to claim 10, wherein the flexible molding member is a flexible rubber; during the molding, downwardly squeezing the flexible rubber by the convex die cover plate, and the flexible rubber deforming and squeezing the outer sidewall of the bottle upper part blank to form the outer ring-shaped step.

13. The production process according to claim 10, wherein four corners of the concave die are fixedly mounted with guide columns perpendicular to an upper surface of the concave die respectively, four corners of the convex die cover plate are formed with guide grooves respectively, and the guide columns are slidably engaged with the guide grooves respectively.

14. The production process according to claim 13, wherein the bottle upper part blank is inserted into the cavity bore, and an outer diameter of the bottle upper part blank is equal to an inner diameter of the cavity bore.

15. The production process according to claim 14, wherein the flexible molding member is a ring-shaped structure, and the flexible molding member is arranged between the cavity step portion and the bottle upper part blank.

16. The production process according to claim 15, wherein a depth of the cavity bore is equal to a height of the bottle upper part blank, and the bottle upper part blank is in contact with a bottom of the cavity bore.

17. The production process according to claim 9, wherein the recess-processing mold comprises a rotating tray, an edge of the rotating tray is defined with four bottom die mounting grooves, the four bottom die mounting grooves respectively are fixedly connected bottom dies therein, a top die assembly is disposed above the rotating tray, one of the bottom dies rotated to a top-most position by the rotating tray is located just below the top die assembly, the top die assembly is movably connected six sets of squeezing components therein, an inner die is fixedly connected in the top die assembly, a downward pressing sleeve is disposed above the top die assembly, and an inner wall of the downward pressing sleeve abuts against the six sets of squeezing components.
